(19) United States
(12) Patent Application Publication
(10) Pub. No.: US 2012/0016793 A1
(43) Pub. Date: Jan. 19, 2012

(54) Wearable Contactless Payment Devices

(76) Inventors: Jo-Ann Peters, Tappan, NY (US); Simon Edward Philips, York (GB)

(21) Appl. No.: 12/373,240

(22) PCT Filed: Jul. 11, 2007
(86) PCT No.: PCT/US07/73250

§ 371 Date: May 16, 2011

Related U.S. Application Data
(60) Provisional application No. 60/830,179, filed on Jul. 11, 2006.

(51) Int. Cl. G06Q 40/00

(52) U.S. Cl. 705/39

(57) ABSTRACT

Contactless payment devices are incorporated in wearable accessories and accouterments. The payment devices include switches, which are operable to activate proximity payment functionality of the devices. The payment devices can optionally include magnetic stripes so that the devices have both proximity and contact payment functionalities.

### CROSS-REFERENCE TO RELATED APPLICATION

This application claims the benefit of U.S. provisional patent application No. 60/830,179, filed on Jul. 11, 2007, which is hereby incorporated by reference in its entirety herein.

### FIELD OF THE INVENTION

This invention relates to payment cards that are used for making electronic payments. In particular, the invention relates to contactless or smart payment cards.

### BACKGROUND OF THE INVENTION

Radio Frequency (RF) tags are small integrated circuits (ICs) connected to an antenna, which can respond to an interrogating RF signal with simple identifying information, or with more complex signals depending on the size of the IC. RF technology does not require contact or line of sight for communication. Radio Frequency (RF) technology is now economically viable and is deployed in more and more commercial and industrial applications. For example, RF technology is now widely used for tags on items in warehouses, shops, ID or access cards, etc. In addition, RF technology has been introduced in the payment card industry (e.g., by MasterCard) in the form of “contactless” payment or credit cards embedded with RF chips. These contactless payment cards can be used to make electronic payment transactions via radio communication with an RF-enabled payment terminal. The contactless payment cards can provide consumers with simple, fast and convenient ways to pay for goods and services, for example, in retail establishments, stores or supermarkets.

Commercially deployed contactless payment cards also may include features such as magnetic stripes and embossed lettering, so that the cards are operable with legacy payment-by-card infrastructure such as magnetic stripe card readers and embossed card paper imprinters that still in use in the field.

The physical characteristics of the contactless cards are based on the earlier ISO 7816-1 Standard for integrated circuit cards. ISO 7816-1 Standard limits the physical size of the contactless cards. A standard card size is the ID-1 size: (85.6 mm×54.0 mm×76 mm). This is the same size as a bank credit card. The ISO standards include accommodation of exposure limits for a number of electromagnetic phenomena such as X-rays, UV light, electromagnetic fields, static electrical fields, and ambient temperature of the card. Furthermore, the ISO standards define the mechanical characteristics of a card when it is bent or flexed. This is to make sure that a plastic card is manufactured in a manner, which ensures acceptable operation over the expected lifetime of the card.

Consideration is now being given to improving the design of contactless payment devices. In particular, attention is being directed to ergonomic or other designs that make the contactless payment devices convenient to use. Payment devices that can be incorporated in a person's normal apparel or accouterments are desirable.

### SUMMARY OF THE INVENTION

In accordance with the present invention, proximity or contactless payment devices that can be incorporated in a person's normal apparel or accouterments are provided. The proximity payment devices may be incorporated in personal items of common use, for example, jeweler, watches, badges, and keys, etc.

A payment device includes a microelectronic chip and a RF antenna which are disposed in a wearable accessory. A proximity payment application in the microelectronic chip provides proximity payment functionality. A mechanical or electro-mechanical On-Off switch coupled to the chip can be used to turn its proximity payment functionality on or off. Alternatively or additionally, an RF-shielding cover can be used limit the range of the proximity payment functionality. An optional visual display (e.g., LED light or screen) can indicate the operational status of the device (e.g., On-Off status), and also provide other payment account information (e.g., account balances) to users.

The microelectronic chip and RF antenna may be disposed on a payment tag or subcard, which is integrated into the payment device/wearable accessory. Such integration may be discrete so that the wearable accessory does not appear to be a payment device to a casual observer. Alternatively, the payment tag or subcard may be prominently integrated in the wearable accessory so that cardholder details and/or branding printed, for example, on the subcard, is on display and visible to the cardholder or merchant.

The payment device may further include a magnetic stripe portion that allows the device to be used as a conventional magnetic stripe payment card or identity card in addition to its use as a proximity payment device. The magnetic stripe portion may be disposed on an exposed portion of the wearable accessory. Alternatively, the magnetic stripe portion may be disposed on or under a movable flap or a flip cover, which can be opened to expose the magnetic stripe portion for use.

An exemplary payment device/wearable accessory is shaped as a flexible frame, which is adaptable for use as a card frame/holder, a bracelet, a hair tie, a wrist band, etc. Other payment devices/wearable accessories may be shaped as adhesive stickers, bracelets, money clips, clips, carabineers, key covers, finger rings, fobs, pendants, etc.

### BRIEF DESCRIPTION OF THE DRAWINGS

Features of the invention, its nature, and various advantages will be more apparent from the following detailed description of the preferred embodiments and the accompanying drawings in which:

FIG. 1 is a schematic illustration of an payment tag for a wearable payment device. The payment tag, which includes RF-chip and antenna circuits, is fabricated in a standard form payment card in accordance with the principles of the present invention.

FIGS. 2A-2E, 3 and 4 are schematic views of a wristband payment device, in accordance with the principles of the present invention.

FIGS. 5A-5Q illustrate exemplary wearable contactless payment devices in accordance with the principles of the present invention.

### DESCRIPTION OF THE INVENTION

The present invention provides contactless payment devices that are incorporated in normal wear clothing items, apparel, jewelry and accouterments. These “wearable” contactless payment devices are designed to make consumer purchase payments easy and convenient, for example, in retail establishments. The “wearable payment devices” include personalized RF-based payment chips that can be sensed and read by suitable RF-chip readers that are deployed in retail establishments. Further, the wearable payment devices may include switching features that allow a consumer to activate or deactivate the payment devices as desired. The wearable payment devices may also include biometric or other security features to prevent unauthorized or unintended use.

Some versions of the wearable payment devices may include conventional magnetic stripe structures or have other features, which are designed to permit use of wearable payment devices as conventional payment cards that are compatible with legacy payment card industry infrastructure (e.g., magstripe card readers).

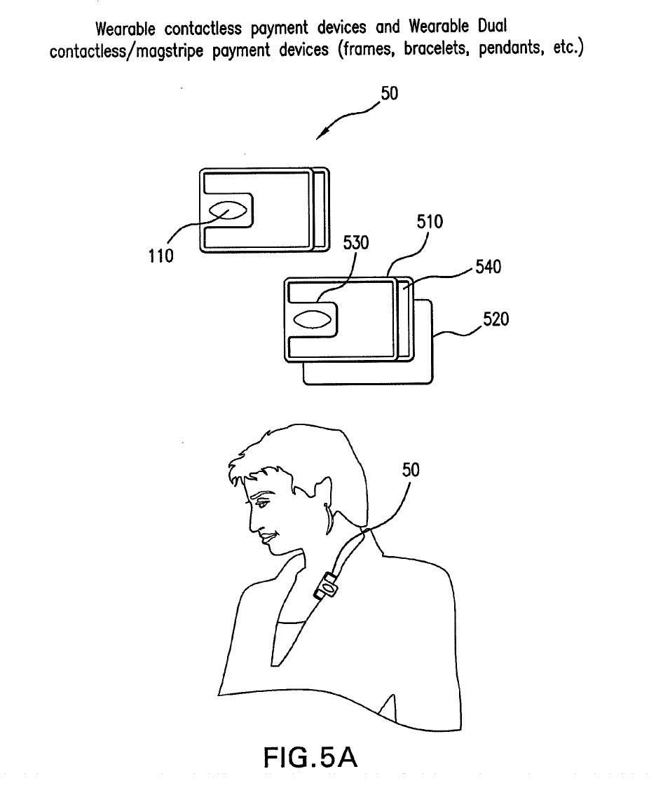

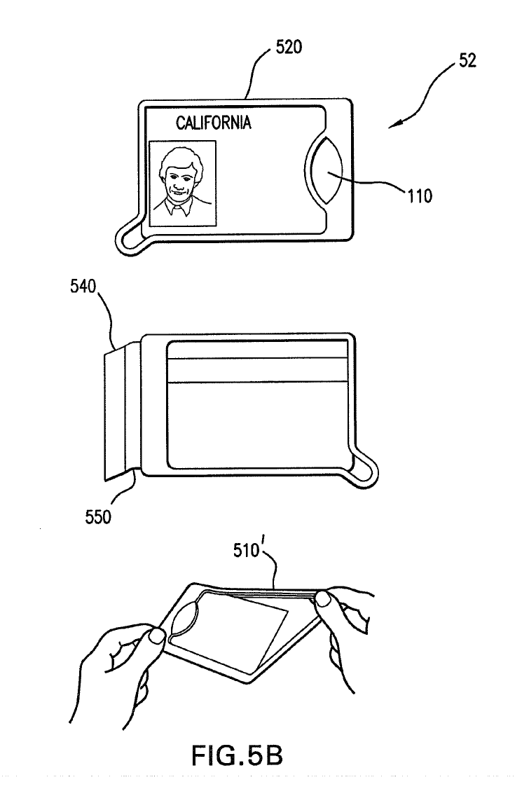

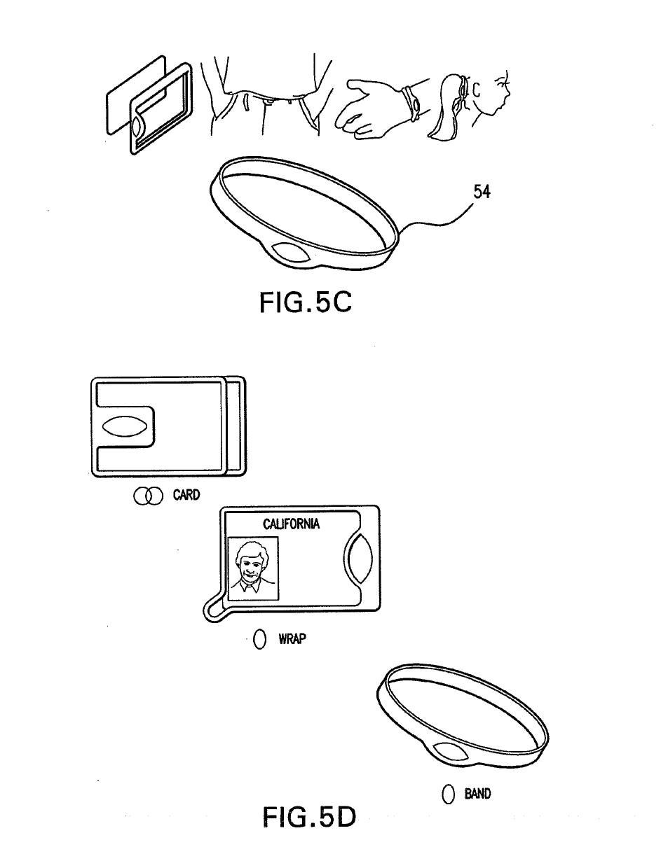

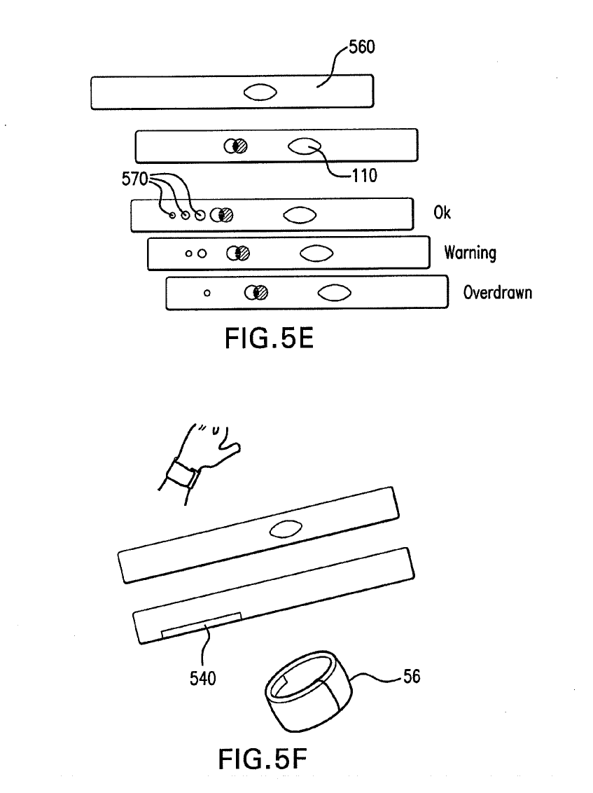

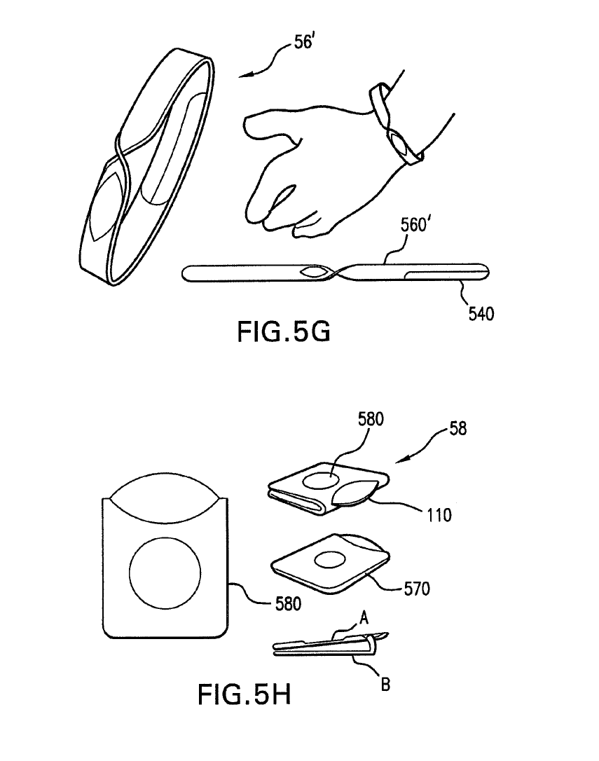

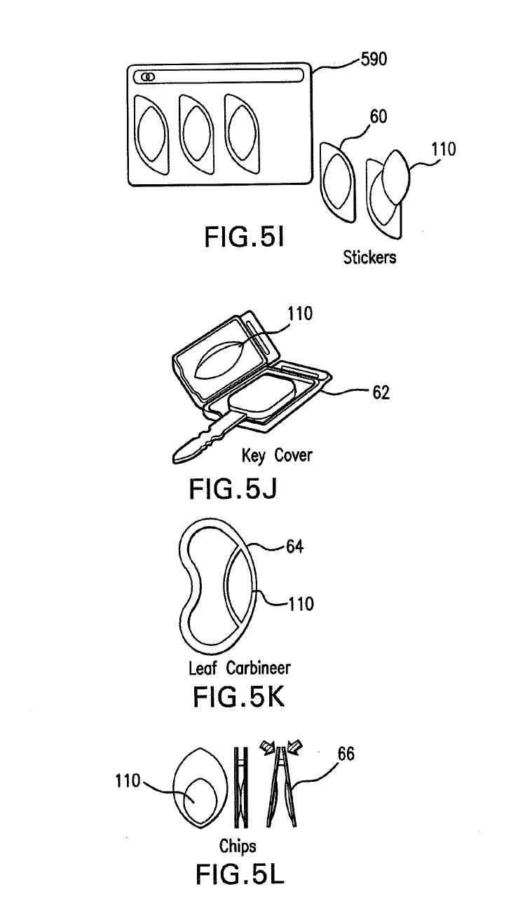

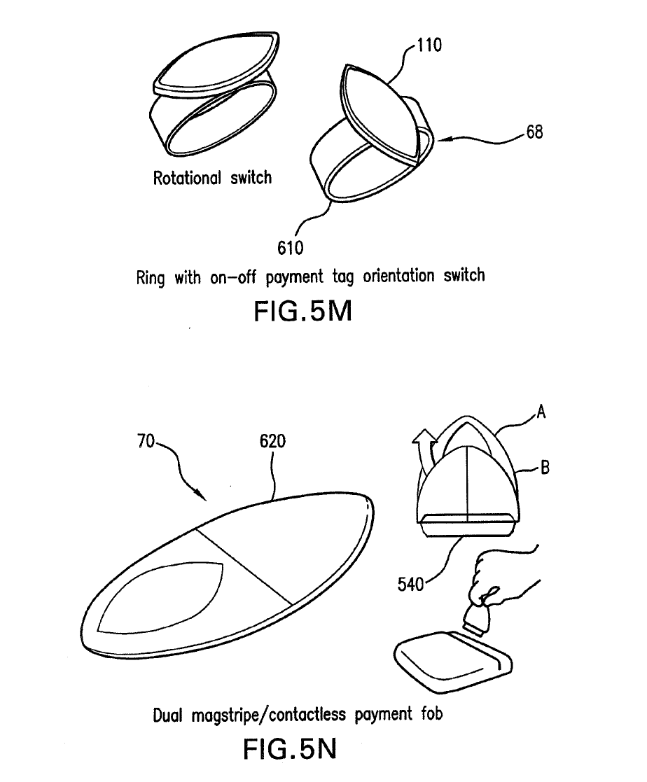

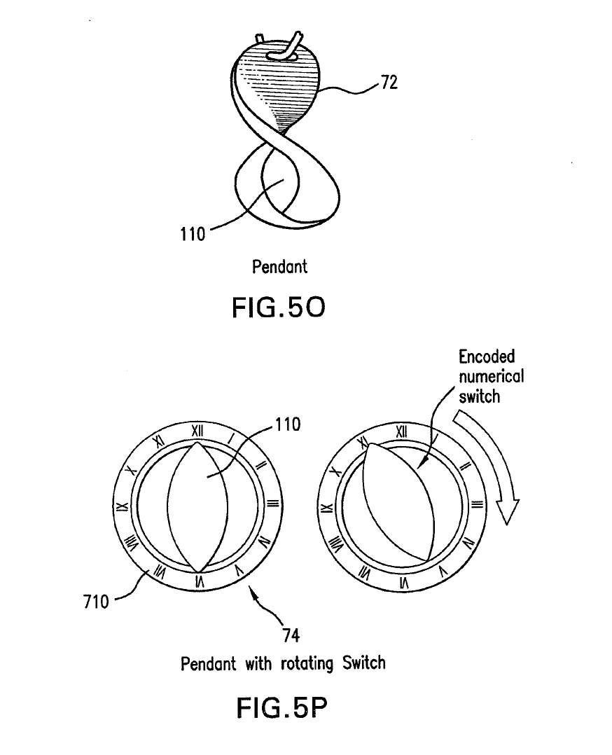

Exemplary wearable payment devices include snap and cuff bracelets, belts, bands of various types including head, waist and wrist bands, card frames, stickers, key covers, pendants, fobs, carabineers, clips and other accessories or adornments. (See FIGS. 5A-5P).

Each of the wearable payment devices includes a personalized RF-chip circuit, which includes customer account and other information needed to electronically process payment transactions in the same or similar manner as payment transactions made with conventional standard form contactless or contact payment cards. The RF-chip circuit, which includes a microprocessor chip and an RF-antenna, may have the same design and fabrication as the RF-chip circuits that are presently used in standard form contactless payment cards (e.g., PayPass cards marketed by assignee MasterCard International Inc.). The RF-chip circuit may be encapsulated or laminated in a payment device structure or tag, which is then incorporated in a wearable device. The wearable device may optionally include magstripe or other conventional payment card structures/features in addition to the contactless payment structures/features

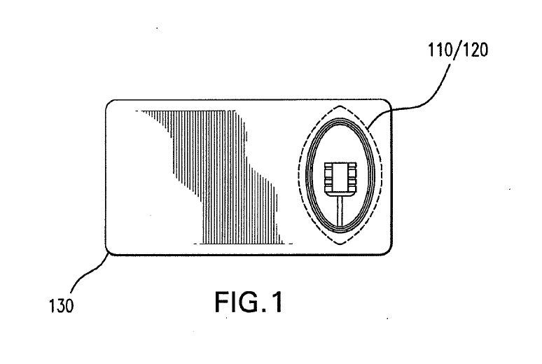

FIG. 1 shows an exemplary arrangement in which a subcard or payment tag 110 for a wearable payment device is fabricated in a detachable portion 120 of a standard rectangular form card structure 130. Detachable portion 120 includes an RF circuit and antenna for contactless payment operation. Detachable portion 120/payment tag 110 may be easily detached from structure 130 and transferred into the wearable payment device (e.g., a bracelet). Payment tag 110 may have any suitable size and shape consistent with the design of the wearable payment device. Apart for its non-standard form, payment tag 110 may have the standard contactless payment card functionality. FIG. 1 shows, for example, payment tag 110, which has an oval or eye shape.

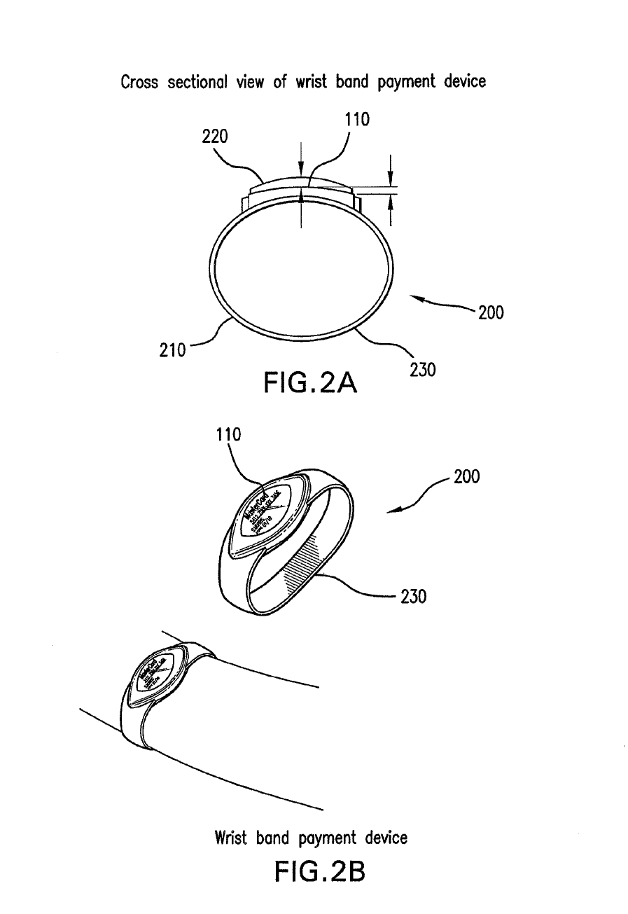

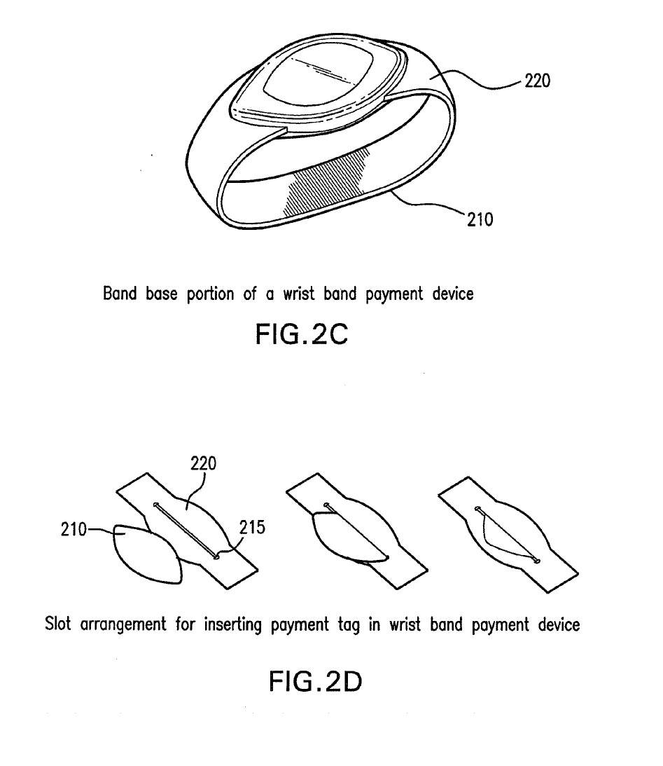

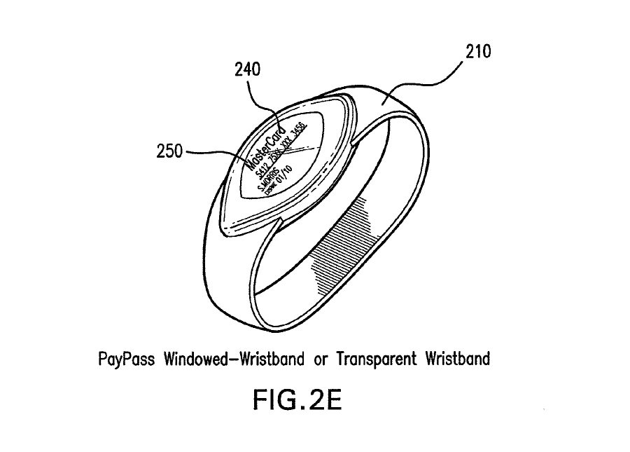

FIGS. 2A-2E show a wristband payment device 200 which includes a detachable oval-shaped payment tag 110. Wristband payment device 200 is designed to be worn on a person's wrist. Wrist band payment device 200 has a band base portion 210 which includes a face portion 220 holding payment tag 110, and one or more straps 230 that are designed to hold wrist band payment device 200 on a person's wrist.

Band base portion 210 may be made from any suitable materials, including fabrics, silicone rubber, or other materials. The materials selected for band base portion 210 may be selected so that they do not interfere with the operation of payment tag 110. Payment tag 110 may be attached to face portion 220 by any suitable mechanical methods including, for example, the use of adhesives, glues and epoxies, friction fit, pins, tabs, or holding frame ridges. Payment tag 110 may be attached or held in face portion 220 in a detachable manner.

In another version of wrist band payment device 200, a cavity in face portion 220 for holding payment tag 210 has a slit slot or opening on the side of base band 310, which allows insertion and removal of the payment tag 210 sideways from the cavity.

In another version of wristband payment device 200, which is shown in FIG. 2D, the cavity in face portion 220 for holding payment tag has a slit opening 215 through flaps at bottom or inside of base band 210. Slit opening 215 allows insertion and removal of the payment tag 110 from the holding cavity.

Base band portion 220 of wristband payment device 200 may be made of opaque materials so that payment tag 110 enclosed in the holding cavity is not visible or apparent, for example, to causal observer. Alternatively, base band portion 220 may include transparent materials so that it is completely clear or has a clear subcard window 240 over the enclosed payment tag 110 so that any cardholder details or branding 250 printed on the subcard is on display, for example, to the cardholder or merchant (FIG. 2E).

In one version of wristband payment device 200 made from silicone rubber, face portion 220 has an open face cavity with a shape similar to that of a payment tag 110. However, the lateral dimensions of the open face cavity are slightly smaller than those of payment tag 110 allowing the latter to be force-fit in the cavity from the top. Payment tag 110 may be exposed so that any cardholder details or branding 250 printed on the subcard is on open display.

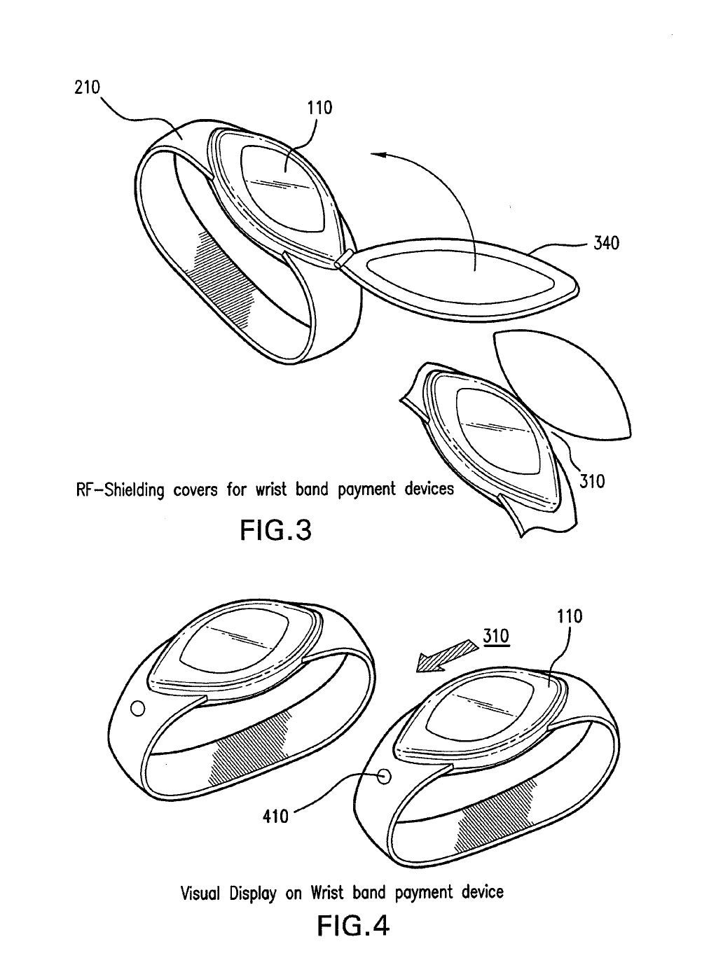

Wristband payment device 200 may include a suitable mechanism by which a user can activate or deactivate payment tag operation as desired (FIG. 3). An exemplary mechanism may be a switch 310 disposed on the side or top of payment tag 110/device 200, which can mechanically or electromechanically interrupt or break the RF-chip and antenna circuits in payment tag 110. The switch may be a pushbutton or a sliding switch.

Another an exemplary mechanism for activating/deactivating may be a movable RF-shielding cap or cover 340 disposed on device 300. (See FIG. 3). RF-shielding cap or cover 340 may be a hinged or sliding cover extending over face portion 210. When RF-shielding cover 340 is in closed position over payment tag 110, it may interfere with RF-signal access to the RF-chip and antenna circuits in payment tag 110 and thereby prevent skimming of chip data or initiation of unauthorized or unwanted payment transactions. Conversely, when RF-shielding cover 340 is intentionally held in open position, RF-signals (e.g., emitted by merchant payment terminals) can access chip data for initiation of authorized or wanted payment transactions.

Wristband payment device 200 may further include a suitable visual displays or indicators (e.g., LCD displays or LEDs), which may be used to display, for example, the operational status (e.g., ON-OFF) of payment tag 110 and/or customer account information (e.g., balance, credit limits, etc.). FIG. 4 shows a wristband payment device 200 with a LED display 410, which indicates the operational status of tag 110. Tag 110 may be activated by a sliding switch mechanism as schematically shown in FIG. 4.

FIGS. 5A-5P show exemplary embodiments of wearable contactless payment devices in the form of frames, bracelets, pendants, etc. Several of the devices are dual contactless/magstripe payment devices.

FIG. 5A shows a wearable payment contact device 50, which has the shape of a card frame. Device 500 includes a frame 510, which may be fabricated from silicone rubber or other suitable polymers and is shaped to hold a card 520 (e.g., a person's ID card). Frame 510 includes a tab or clip portion 530, which allows payment device 50 to be worn on a person's clothing. Further, frame 510 may optionally include a magnetic stripe potion 540, which allows device 50 to be used a conventional magnetic stripe payment card.

FIG. 5B shows another payment contact device 52, which has the shape of a card frame. Like device 50, device 52 includes a frame 510′, which is shaped to hold a card 520 (e.g., a person's drivers license card). Frame 510′ include an embedded payment tag 110 and an optional flap 550 having a magnetic stripe portion 540.

FIG. 5C shows alternative configurations of payment contact device 52, in which frame 510′ is used by itself as a wristband 54, or a personal clothing or hair braid accessory device 54. FIG. 5D shows the topological similarities between devices 50, 52, and 54 based on frame shapes 510 and 510′.

FIGS. 5E and 5F shows an exemplary bracelet payment device 56 that can be worn, for example, on a person's wrist. Device 56 may be made from a curlable band 560 having an embedded payment tag 110. Band 560 may include account balance indicators (e.g., LEDs 570) coupled to payment tag 110 using suitable circuitry. LEDs 570 provide visual display of account balance status (e.g., available, near limit, overdrawn, etc.) of the payment device. Further, band 560 may include a magnetic stripe 540, which allows use of the bracelet payment device 56 as a conventional magnetic stripe payment device (e.g., when band 560 is uncurled to a straight form). FIG. 5G shows an exemplary twist bracelet payment device 56′ based on a curlable band 560′, which is similar to band 560 but includes twist shapes. When bracelet 56′ is held flat, magnetic stripe 540 allows the device to be used as a conventional magnetic stripe payment device.

FIG. 5H shows an exemplary payment device 58 shaped as a money clip. Device 58 has a body 570 with front and back leaves A and B, which are connected together by a spring or other elastic mechanism. Body 570 may be made from anodized aluminum and/or other suitable materials. Payment tag 110 is embedded in body 570. Further, an optional biometric security device (e.g., a fingerprint reader 580), which is linked to payment 110, is disposed on body 570. In operation, a person who is using device 58 may be required to activate payment tag 110 by placing his or her finger on reader 580 for identity verification.

FIG. 5I shows exemplary payment device 60 shaped as an adhesive sticker, which includes payment tag 110. One or more devices 60 may be packaged for distribution on adhesive backing sheet 590. A device 60 can be removed from adhesive backing sheet 590 and placed a person's body, clothing or other belongings (e.g., book, bag, bicycle, etc.) to function a “traveling” payment device.

FIGS. J and K show payment device 62 and 64 that are shaped like a key cover and a carbineer, respectively. FIG. 5I shows exemplary payment device 66 shaped as a wearable clip that can be clipped, for example, to a person's clothing or bag. Each of devices 62-66 includes a payment tag 110, which provides proximity payment functionality.

FIG. 5M shows exemplary payment device 68, which is shaped as a finger ring 610. Payment tag 110 is disposed on top of the ring. Payment device 68 may include an optional switch mechanism for activating payment tag 110. A suitable switch may be a mechanical orientation switch carrying payment tag 110, which is configured so that payment tag 110 is turned on or off according to the physical orientation of payment tag 110 relative to ring body 610.

FIG. 5N shows exemplary payment device 70, which has an oval body 620 shaped as a fob device. A payment tag 110 and an optional magnetic stripe 540 is embedded in body 620. Further, two portions A and B of body 620 may be configured to flip (or slide) relative to each other to expose an enclosed magnetic stripe 540, which allows the device to be used as a conventional magnetic stripe payment device. Any suitable mechanical designs may be used of the construction of a flip device 70. Alternative structures of payment device 70 may include biometric fingerprint or conventional mechanical activation/deactivation switches for activating payment tag 110.

FIG. 5O shows exemplary payment device 72, which is shaped a pendant that can be worn, for example, on a necklace. FIG. 5P shows another exemplary payment device 74 having a pendant design. Payment device 74 includes payment tag 110 which disposed on a pendant body 710. A clock-like or encoded numerically switch mechanism may be used to connect payment tag 110 and pendant body 710 such that a user has to rotate payment tag 110 to a particular encoded position (e.g., 5 o'clock position) to activate payment tag 110.

Although the present invention has been described in connection with specific exemplary embodiments, it should be understood that various changes, substitutions, and alterations apparent to those skilled in the art can be made to the disclosed embodiments without departing from the spirit and scope of the invention.

1. A payment device comprising:
a wearable accessory;
a microelectronic chip;
a RF antenna and a proximity payment application disposed on the microelectronic chip, the proximity payment application providing proximity payment functionality to the device.

2. The payment device of claim 1, wherein the wearable accessory is shaped as a wristband that is wearable on a person's wrist.

3. The device of claim 2, further comprising a payment tag having disposed therein the microelectronic chip and the RF antenna.

4. The device of claim 3 wherein the wristband comprises a slot adapted to receive and hold the payment tag.

5. The device of claim 1 further comprising an On-Off switch coupled to the microelectronic chip, the switch operable to activate and deactivate the chip's proximity payment functionality.

6. The device of claim 1 wherein the On-Off switch comprises one of a sliding switch, a rotational switch, an orientational switch, and an encoded number switch.

7. The device of claim 1 further comprising a movable RF-shielding cover.

8. The payment device of claim 1 wherein the wearable accessory further comprises a biometric reader.

9. The device of claim 1 further comprising a display that indicates the operational status of the device.

10. The payment device of claim 1 wherein the wearable accessory further comprises a magnetic stripe portion that provides magnetic stripe card functionality to the device.

11. The payment device of claim 10 wherein the wearable accessory further comprises one of a movable flap and a flip cover, which can be opened to expose the magnetic stripe portion for use.

12. The payment device of claim 1 wherein the wearable accessory is shaped as a flexible frame.

13. The payment device of claim 12 wherein the flexible frame is adaptable for use as at least one of a cardholder, a bracelet, a hair tie, a wrist band.

14. The payment device of claim 1 wherein the wearable accessory is shaped as one of an adhesive sticker, a bracelet, a clip, a leaf carbineer, a key cover, a ring, a fob and a pendant
